(19) United States
(12) Patent Application Publication
(10) Pub. No.: US 2014/0063183 A1
(43) Pub. Date: Mar. 6, 2014

(54) METHOD OF PROCESSING MULTI-VIEW IMAGE AND APPARATUS FOR EXECUTING THE SAME

(71) Applicants: Sung Ho ROH, Seoul (KR); Jun Shik JEON, Yongin-si, Gyeonggi-do (KR); Tae Hyun KIM, Seongnam-si, Gyeonggi-do (KR)

(72) Inventors: Sung Ho ROH, Seoul (KR); Jun Shik JEON, Yongin-si, Gyeonggi-do (KR); Tae Hyun KIM, Seongnam-si, Gyeonggi-do (KR)

(21) Appl. No.: 14/014,928

(22) Filed: Aug. 30, 2013

(30) Foreign Application Priority Data
Aug. 30, 2012 (KR) 10-2012-0095404

(51) Int. Cl. H04N 13/00

(52) U.S. Cl. CPC H04N 13/0048
USPC 348/42

(57) ABSTRACT

A method of processing a multi-view image, and a multi-view image processing apparatus for performing the method are provided. The multi-view image processing apparatus includes a first video codec module which is configured to output first image processed data as a result of processing a first image signal provided from a first image source, and to generate sync information at each predetermined time, and a second video codec module which is configured to output second image processed data as a result of processing a second image signal provided from a second image source, using part of the output first image processed data according to the sync information. The first image processed data and the second image processed data are combined into a multi-view image.

### CROSS-REFERENCE TO RELATED APPLICATIONS

This application claims priority from Korean Patent Application No. 10-2012-0095404 filed on Aug. 30, 2012, the disclosure of which is hereby incorporated by reference in its entirety.

### BACKGROUND

Exemplary embodiments relate to a method of processing an image. More particularly, exemplary embodiments relate to a method of processing a multi-view image using a plurality of video codec modules and apparatuses, e.g., a system-on-chip (SoC), and an image processing system including the same for executing the method.

Multi-view coding is a three-dimensional (3D) image processing technique by which images shot by two or more cameras are geometrically corrected and spatially mixed to provide users multiple points of view. It is also called 3D video coding.

In a related art, video source data or video streams having multiple points of view are processed using a single video codec module. In other words, after first data of a first view is processed, first data of a second view is processed. After first data of all views, i.e., the first and second views are processed, second data of the first view and second data of the second view are sequentially processed. In other words, in processing data of multiple views using a single video codec module, the first data of the respective views are all sequentially processed, and only then, the second data of the respective view are sequentially processed.

In the related art, when data of two views are processed using a single video codec module that can process 60 frames per second, 30 frames are processed for each view. Since the processing performance for each view decreases by half, problems may occur.

For example, in the related art, when an input source of 60 frames is input to an encoder for a second for each view, a total amount of data to be processed is 120 frames per second. Accordingly, the input source of the related art cannot be processed with the module that processes 60 frames per second. To overcome this problem, the input source of the related art is downscaled to a size of 30 frames per second for each view, such that a frame rate is decreased. In the related art, when an input data stream of 60 frames is input to a decoder for a second for each view, a total amount of data to be processed is 120 frames per second. As in the encoder, the input data stream of the related art cannot be processed for a second with the module that processes 60 frames per second. However, unlike the encoder, the amount of input data can be downscaled by half in the decoder. In this case, the decoder of the related art processes 60 frames per second, and displays images two times slower than an original speed.

### SUMMARY

According to an aspect of the exemplary embodiments, there is provided a method of processing a multi-view image using an image processing apparatus including a first video codec module and a second video codec module. The method includes the first video codec module processing a first frame of a first image signal and sending sync information to a host and the second video codec module processing a first frame of a second image signal, with reference to the processed data of the first frame of the first image signal. Here, a time in which the second video codec module starts the processing of the first frame of the second image signal is determined based on the sync information and the first image signal and the second image signal are processed in parallel by the first video codec module and the second video codec module.

The first image signal may be provided from a first image source and the second image signal may be provided from a second image source, which is different from the first image source.

Alternatively, the first and second image signals may be provided from a single image source.

The method may further include the first video codec module processing an i-th frame of the first image signal, with reference to the processed data of at least one previous frame of the i-th frame, and sending the sync information to the host; and the second video codec module processing an i-th frame of the second image signal, with reference to the processed data of the i-th frame of the first image signal according to control of the host, where “i” is an integer of at least 2.

The sync information may be frame sync information.

According to another aspect of the exemplary embodiments, there is provided a method of processing a multi-view image using an image processing apparatus including a first video codec module and a second video codec module. The method includes the first video codec module generating sync information every time data of a predetermined unit has been processed in a first frame of a first image signal; the second video codec module determining whether a reference block in the first frame of the first image signal has been processed according to the sync information; and the second video codec module processing a first frame of a second image signal with reference to the processed data of the reference block.

The predetermined unit may be a row, and the sync information may be row sync information.

The method may further include the first video codec module processing an i-th frame of the first image signal, with reference to the processed data of at least one previous frame of the i-th frame, and sending the sync information to the second video codec module every time data of each row in the i-th frame is processed; the second video codec module determining whether a reference block in the i-th frame of the first image signal has been processed according to the sync information; and the second video codec module processing an i-th frame of the second image signal, with reference to the processed data of the reference block in the i-th frame, where “i” is an integer of at least 2.

Alternatively, the predetermined unit may be a block, and the sync information may be stored in a bitmap memory.

At this time, the method may further include the first video codec module processing an i-th frame of the first image signal with reference to the processed data of at least one previous frame of the i-th frame, and setting a corresponding bit in the bitmap memory every time data of each block in the i-th frame is processed; the second video codec module reading a value from the bitmap memory and determining whether a reference block in the i-th frame of the first image signal has been processed according to the value read from the bitmap memory; the second video codec module processing an i-th frame of the second image signal, with reference to the processed data of the reference block; and combining the processed data of the i-th image of the first image signal with the processed data of the i-th frame of the second image signal into a multi-view image, where “i” is an integer of at least 2.

According to another aspect of the exemplary embodiments, there is provided a multi-view image processing apparatus including a first video codec module which is configured to output first image processed data as a result of processing a first image signal provided from a first image source, and to generate sync information at each predetermined time and a second video codec module which is configured to output second image processed data as a result of processing a second image signal provided from a second image source, using part of the output first image processed data according to the sync information. The first image processed data and the second image processed data are combined into a multi-view image.

The first image signal and the second image signal may include a plurality of frames, and the sync information may be generated every time the first video codec module processes each of the frames of the first image signal.

Alternatively, the first image signal and the second image signal may include a plurality of frames. Each of the frames may include a plurality of rows. The first video codec module may include a first sync transceiver which is configured to generate the sync information every time data of a row in each frame of the first image signal is processed. The second video codec module may include a second sync transceiver which is configured to receive the sync information from the first video codec module.

As another alternative, each of the frames may include a plurality of blocks. The second sync transceiver of the second video codec module may determine whether a reference block of the first image signal, which is referred to when a block of the second image signal is processed, has been processed using the sync information.

Each of the first and second video codec modules may include at least one of an encoder which is configured to encode an input signal, and a decoder which is configured to decode the input signal.

The first video codec module may send the sync information to a host, and the second video codec module may receive the sync information from the host. Alternatively, the first video codec module may include a first sync transceiver which is configured to transmit the sync information to the second video codec module, and the second video codec module may include a second sync transceiver which is configured to receive the sync information from the first video codec module.

Alternatively, the first video codec module may store the sync information in memory, and the second video codec module may read the sync information from the memory.

The first video codec module and the second video codec module may be implemented together in a single hardware module.

The first and second video codec modules may have a same specification (e.g., a same hardware specification).

According to another aspect of the exemplary embodiments, there is provided a method of processing a multi-view image using an image processing apparatus including a first video codec module and a second video codec module. The method includes the first video codec module sequentially receiving and processing a plurality of frames of a first image signal; the second video codec module sequentially receiving and processing a plurality of frames of a second image signal; and combining processed data of each frame of the first image signal and processed data of a corresponding frame of the second image signal into a multi-view image. The second video codec module may process each frame of the second image signal using at least part of the processed data of a corresponding frame of the first image signal according to sync information generated by the first video codec module.

The sync information may be generated every time when the first video codec module processes each of the frames of the first image signal.

The frames included in each of the first and second image signals may include a plurality of rows. The sync information may be generated every time when the first video codec module processes data of a row in each of the frames of the first image signal.

The method may further include the second video codec module determining whether a reference block in a first frame of the first image signal has been processed according to the sync information.

The frames included in each of the first and second image signals may include a plurality of blocks and the sync information may be generated every time when the first video codec module processes data of a block in each of the frames of the first image signal.

The method may further include storing the sync information, which includes bitmap data indicating whether the data of the block in each frame of the first image signal has been processed, in memory; and the second video codec module reading the bitmap data from the memory.

The method may further include the second video codec module determining whether the data of the block in each frame of the first image signal has been processed according to the bitmap data.

According to another aspect of the exemplary embodiments, there is provided a method of processing a multi-view image using an image processing apparatus including a first video codec module and a second video codec module. The method includes the first video codec module processing data of each block in a first frame of a first image signal and setting a bit in a bitmap memory every time when processing the data of the block; the second video codec module reading the bit from the bitmap memory and determining whether a reference block in the first frame of the first image signal has been processed according to the bit read from the bitmap memory; and the second video codec module processing a first frame of a second image signal with reference to processed data of the reference block in the first frame of the first image signal.

According to another aspect of the exemplary embodiment, there is provided a codec module for processing a multi-view image signal. The codec module includes a first video codec module which is configured to process a first image signal in the multi-view image, and output first image processing data and sync information; and a second video codec module which is configured to process a second image signal in the multi-view image, and output second image processing data. The second video codec module may process the second image signal using part of the first image processing data according to the sync information output from the first video codec module. The first codec module and the second codec module may perform parallel processing of the multi-view image signal.

### BRIEF DESCRIPTION OF THE DRAWINGS

The above and other features and advantages of the exemplary embodiments will become more apparent by describing in detail exemplary embodiments with reference to the attached drawings in which:

FIG. 1 is a block diagram of an image processing system according to some embodiments

FIG. 2 is a functional block diagram of a first video codec module and a second video codec module according to some embodiments;

FIG. 3 is a diagram for explaining a method of processing a multi-view image according to some embodiments;

FIG. 4 is a functional block diagram of a first video codec module and a second video codec module according to other embodiments;

FIG. 5 is a diagram for explaining the frame structure of first and second image signals according to some embodiments;

FIG. 6 is a diagram for explaining a method of processing a multi-view image according to other embodiments;

FIG. 7 is a functional block diagram of a first video codec module and a second video codec module according to further embodiments;

FIG. 8 is a diagram for explaining the frame structure of first and second image signals according to other embodiments;

FIG. 9 is a diagram of an example of a bitmap memory;

FIG. 10 is a diagram for explaining a method of processing a multi-view image according to further embodiments;

FIG. 11 is a flowchart of a method of processing a multi-view image according to some embodiments;

FIG. 12 is a flowchart of a method of processing a multi-view image according to other embodiments;

FIGS. 13A through 15B are block diagrams of the structure of first and second video codec modules according to different embodiments;

FIGS. 16 through 18 are block diagrams of the structure of first and second video codec modules according to other different embodiments; and

FIG. 19 is a block diagram of an image processing system 400 according to other embodiments.

### DETAILED DESCRIPTION OF THE EXEMPLARY EMBODIMENTS

Exemplary embodiments will be described more fully hereinafter with reference to the accompanying drawings, in which embodiments are shown. Exemplary embodiments may, however, be embodied in many different forms and should not be construed as limited to the embodiments set forth herein. Rather, these embodiments are provided so that this disclosure will be thorough and complete, and will fully convey the scope of the exemplary embodiments to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the exemplary embodiments. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

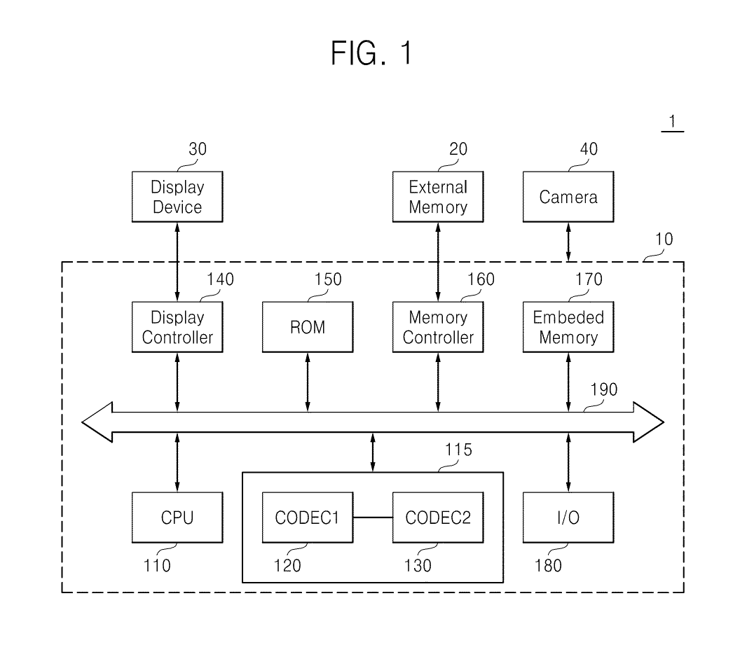

FIG. 1 is a block diagram of an image processing system 1 according to some embodiments. The image processing system 1 may include an image processing apparatus 10, an external memory device 20, a display device 30, and a camera module 40. The image processing apparatus 10 may be implemented as a system-on-chip (SoC), and may be an application processor.

The image processing apparatus 10 may include a central processing unit (CPU) 110, a codec module 115, a display controller 140, a read-only memory (ROM) 150, an embedded memory 170, a memory controller 160, an interface module 180, and a bus 190. However, components of the image processing apparatus 10 may be added or subtracted according to different embodiments. In other words, the image processing apparatus 10 may not include some of the components illustrated in FIG. 1, or may include other components than those illustrated in FIG. 1. For instance, a power management module, a television (TV) processor, a clock module, and a graphics processing unit (GPU) may be further included in the image processing apparatus 10.

The CPU 110 may process or execute programs and/or data stored in the memory 150, 170, or 20. The CPU 110 may be implemented by a multi-core processor. The multi-core processor is a single computing component with two or more independent actual processors (referred to as cores). Each of the processors may read and execute program instructions. The multi-core processor can drive a plurality of accelerators at a time. Therefore, a data processing system including the multi-core processor may perform multi-acceleration.

The codec module 115 is a module for processing a multi-view image signal. It may include a first video codec module 120 and a second video codec module 130.

The first video codec module 120 may encode or decode a first image signal in the multi-view image signal. The second video codec module 130 may encode or decode a second image signal in the multi-view image signal. Although only two video codec modules 120 and 130 are illustrated in FIG. 1, there may be three or more video codec modules.

As described above, a plurality of video codec modules are provided to perform parallel process of the multi-view image signal in the current embodiments. The structure and the operations of the first and second video codec modules 120 and 130 will be described later.

The ROM 150 may store permanent programs and/or data. The ROM 150 may be implemented by erasable programmable ROM (EPROM), or electrically erasable programmable ROM (EEPROM).

The embedded memory 170 is a memory embedded in the image processing apparatus 10 implemented as a SoC. The embedded memory 170 may store programs, data, or instructions. The embedded memory 170 may store image signals to be processed by the first and second video codec modules 120 and 130, i.e., data input to the first and second video codec modules 120 and 130. The embedded memory 170 may also store image signals that have been processed by the first and second video codec modules 120 and 130, i.e., data output from the first and second video codec modules 120 and 130. The embedded memory 170 may be implemented by volatile memory and/or non-volatile memory.

The memory controller 160 is used for interface with the external memory device 20. The memory controller 160 controls the overall operation of the external memory device 20 and controls the data communication between a master device and the external memory device 20. The master device may be a device such as the CPU 110 or the display controller 140.

The external memory device 20 is a storage for storing data and may store an operating system (OS) and various kinds of programs and data. The external memory device 20 may be implemented by DRAM, but the exemplary embodiments are not restricted to the current embodiments. The external memory device 20 may be implemented by non-volatile memory, such as flash memory, phase-change RAM (PRAM), magnetoresistive RAM (MRAM), resistive RAM (ReRAM), or ferroelectric RAM (FeRAM).

The external memory device 20 may store image signals to be processed by the first and second video codec modules 120 and 130, i.e., data input to the first and second video codec modules 120 and 130. The external memory device 20 may also store image signals that have been processed by the first and second video codec modules 120 and 130, i.e., data output from the first and second video codec modules 120 and 130. The components of the image processing apparatus 10 may communicate with one another through a system bus 190.

The display device 30 may display multi-view image signals. The display device 30 may be a liquid crystal display (LCD) device in the current embodiments, but the exemplary embodiments are not restricted to the current embodiments. In other embodiments, the display device 30 may be a light emitting diode (LED) display device, an organic LED (OLED) display device, or one of other types of display devices.

The display controller 140 controls the operations of the display device 30. The camera module 40 is a module that can convert an optical image into an electrical image. Although not shown in detail, the camera module 40 may include at least two cameras, e.g., first and second cameras. The first camera may generate a first image signal, corresponding to a first view in a multi-view image, and the second camera may generate a second image signal, corresponding to a second view in the multi-view image.

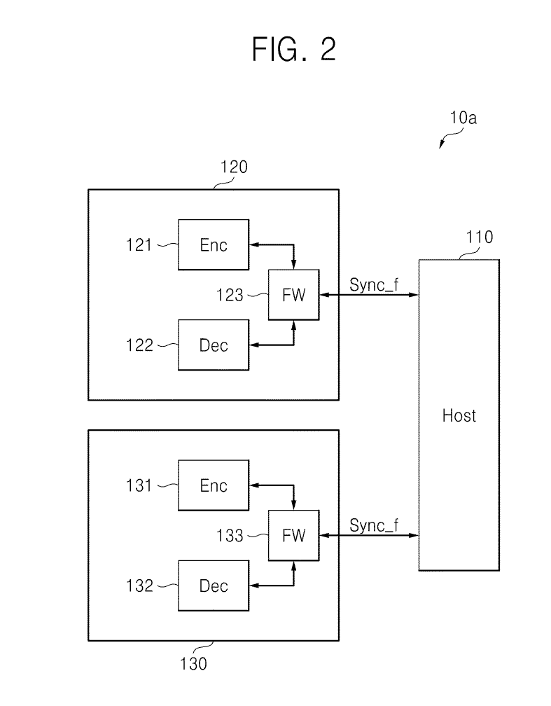

FIG. 2 is a functional block diagram of the first video codec module 120 and the second video codec module 130 according to some embodiments. The first video codec module 120 includes an encoder 121, a decoder 122, and firmware 123. Similar to the first video codec module 120, the second video codec module 130 includes an encoder 131, a decoder 132, and firmware 133. A host 110 may be the CPU 110 illustrated in FIG. 1. The host 110 controls the operations of the first and second video codec modules 120 and 130.

The first video codec module 120 processes the first image signal in the multi-view image and outputs first image processing data. The first video codec module also outputs sync information Sync_f. The first image signal is an image signal of the first view, for example, an image signal shot by the first camera. When the first image signal is a signal to be encoded, the encoder 121 encodes the first image signal and outputs a result. When the first image signal is a signal to be decoded, the decoder 122 decodes the first image signal and outputs a result. The sync information Sync_f may be frame sync information generated every time when processing (e.g., encoding or decoding) of a frame of the first image signal is completed.

The second video codec module 130 processes the second image signal in the multi-view image and outputs second image processing data. At this time, the second video codec module 130 may process the second image signal using part of the first image processing data according to the sync information Sync_f output from the first video codec module 120. The second image signal is an image signal of the second view, for example, an image signal shot by the second camera.

An image processing apparatus 10a of an example of the image processing apparatus 10 illustrated in FIG. 1 may combine the first image processing data and the second image processing data to output the multi-view image to the display device 30 (FIG. 1). The image processing apparatus 10a may be implemented as a SoC.

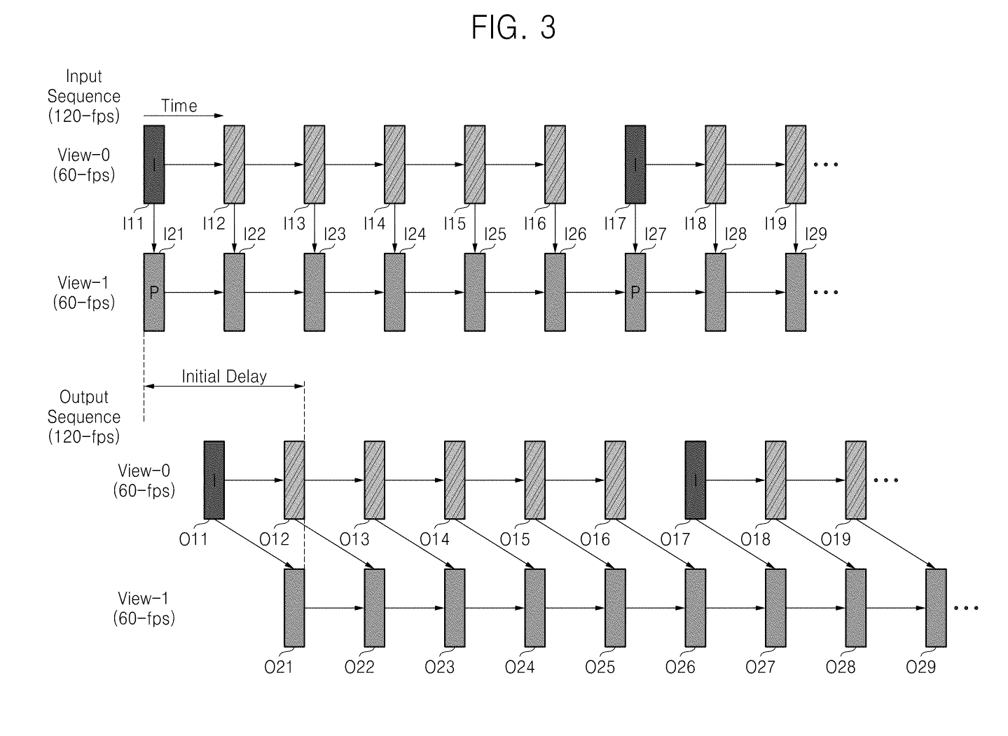

FIG. 3 is a diagram for explaining a method of processing a multi-view image according to some embodiments. The method illustrated in FIG. 3 may be performed by the image processing apparatus 10a including the first and second video codec modules 120 and 130 illustrated in FIG. 2.

Referring to FIGS. 2 and 3, a multi-view image signal (view-0 and view-1) may be input from at least two image sources (e.g., cameras). It is assumed that there are two image sources and a multi-view is 2-view in the current embodiments, but the exemplary embodiments are not restricted to the current embodiments. In other embodiments, the multi-view image signal may be input from a single image source.

An image signal of a first view view-0 is referred to as a first image signal. The first image signal may be input to the first video codec module 120 at a predetermined rate. The rate may be expressed in frames per unit time, e.g., frames per second (fps). For instance, the first image signal may be input at a rate of 60 fps. An image signal of a second view view-1 is referred to as a second image signal. The second image signal may be input to the second video codec module 130 at the same rate (e.g., 60 fps) as the first image signal.

The first and second image signals may be signals that will be encoded or decoded. For instance, when each of the first and second image signals is generated by and input from a camera, the first and second image signals may be encoded by the encoders 121 and 131, respectively, of the respective first and second video codec modules 120 and 130 and stored in the memory 170 or 20 (FIG. 1). When the first and second image signals have been encoded and stored in the memory 170 or 20, they may be respectively decoded by the decoders 122 and 132 of the respective first and second video codec modules 120 and 130, and displayed on the display device 30 (FIG. 1).

The first video codec module 120 may sequentially receive and process a plurality of frames I11 through I19 of the first image signal, and may generate the sync information Sync_f every time when processing of a frame is complemented. When the first video codec module 120 processes a current frame, i.e., an i-th frame of the first image signal, it may refer to processed data of at least one of previous frames, e.g., (i-1)-th through (i-16)-th frames.

When the first image signal is a signal to be encoded, the encoder 121 of the first video codec module 120 sequentially encodes the first through ninth frames I11 through I19 of the first image signal, and outputs encoded data O11 through O19. The firmware 123 of the first video codec module 120 provides the host 110 with the sync information Sync_f every time each of the frames I11 through I19 is completely encoded.

When the first image signal is a signal to be decoded, the encoder 121 of the first video codec module 120 sequentially decodes the first through ninth frames I11 through I19 of the first image signal and outputs decoded data O11 through O19. The firmware 123 of the first video codec module 120 provides the host 110 with the sync information Sync_f every time when each of the frames I11 through I19 is completely decoded.

The host 110 may control the operation of the second video codec module 130 according to the sync information Sync_f.

The second video codec module 130 sequentially receives and processes a plurality of frames I21 through I29 of the second image signal. When the second video codec module 130 processes each frame of the second image signal, it refers to the processed data of a corresponding frame of the first image signal. Accordingly, the second video codec module 130 waits for the corresponding frame of the first image signal to be completely processed.

When the sync information Sync_f is generated by the first video codec module 120 after a frame of the first image signal is completely processed by the first video codec module 120, the second video codec module 130 processes a corresponding frame of the second image signal with reference to processed data of the frame of the first image signal in response to the sync information Sync_f. For instance, the second video codec module 130 processes a first frame I21 of the second image signal with reference to the processed data O11 of the first frame I11 of the first image signal.

When the second image signal is encoded, the encoder 131 of the second video codec module 130 may sequentially encode first through ninth frames I21 through I29 of the second image signal with reference to the encoded data O11 through O19 of the respective frames I11 through I19 of the first image signal, and output encoded data O21 through O29. When the second image signal is decoded, the decoder 132 of the second video codec module 130 may sequentially decode the first through ninth frames I21 through I29 of the second image signal with reference to the decoded data O11 through O19 of the respective frames I11 through I19 of the first image signal, and output decoded data O21 through O29.

Accordingly, an initial delay from a time when the first frames I11 and I21 of the respective first and second image signals are input to a time when the first frames I11 and I21 are completely processed is illustrated in FIG. 3.

When the second video codec module 130 processes a current frame, i.e., an i-th frame of the second image signal, the second video codec module 130 may refer to processed data of at least one of previous frames of the second image signal as well as the processed data of the first image signal. The maximum number of previous frames that can be referred to may be 16, but the number is not restricted.

The processed data O11 through O19 of the first image signal and the processed data O21 through O29 of the second image signal may be stored in the memory 170 or 20 (FIG. 1) or may be transmitted to a network outside the image processing system 1. The processed data O11 through O19 of the first image signal and the processed data O21 through O29 of the second image signal may be combined into a multi-view image.

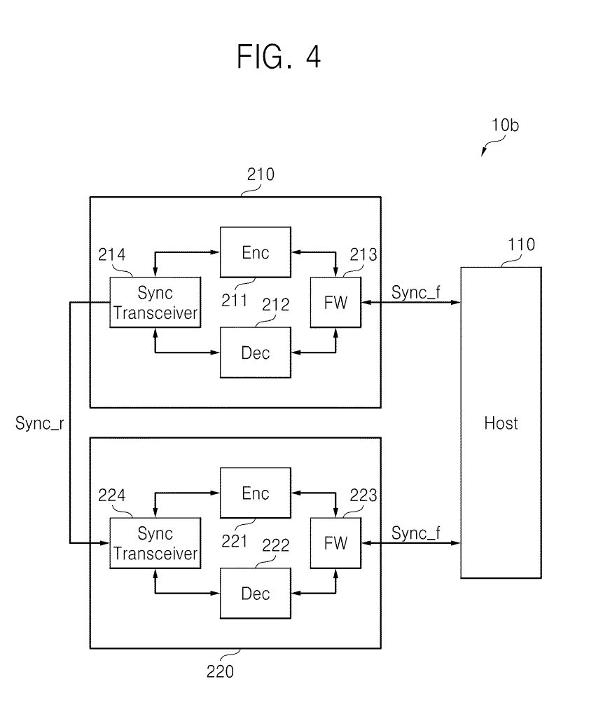

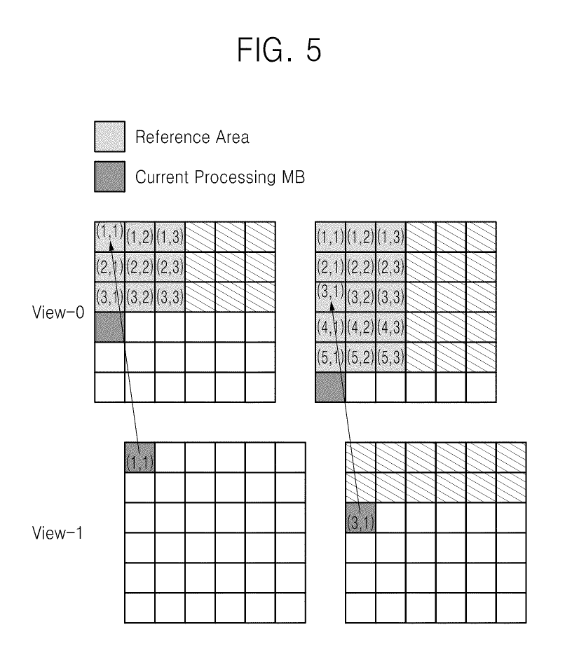

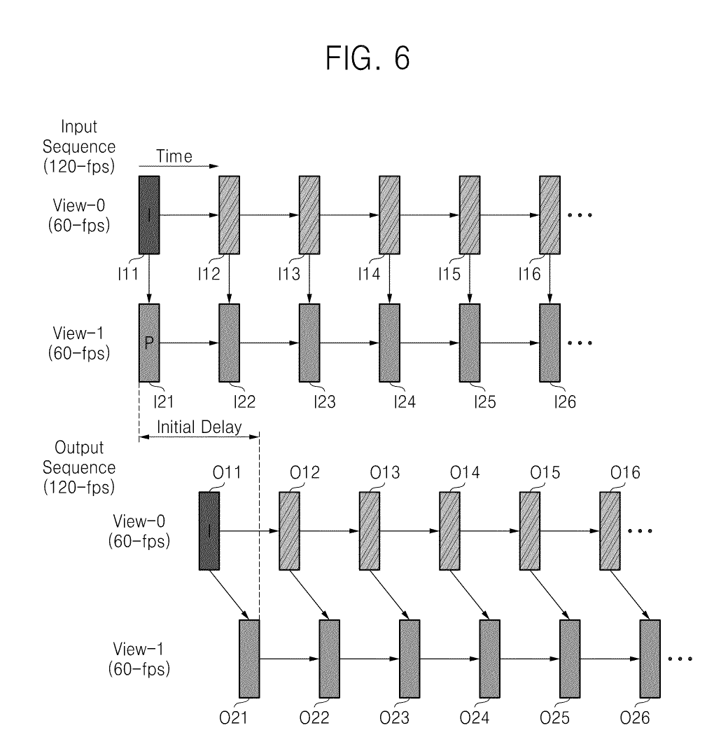

FIG. 4 is a functional block diagram of a first video codec module 210 and a second video codec module 220, according to other embodiments. FIG. 5 is a diagram for explaining the frame structure of first and second image signals according to some embodiments. FIG. 6 is a diagram for explaining a method of processing a multi-view image according to other embodiments. The method illustrated in FIG. 6 may be performed by an image processing apparatus 10b, including the first and second video codec modules 210 and 220 illustrated in FIG. 4.

Referring to FIGS. 4 through 6, the first video codec module 210 includes an encoder 211, a decoder 212, firmware 213, and a sync transceiver 214. The second video codec module 220 includes an encoder 221, a decoder 222, firmware 223, and a sync transceiver 224.

The first video codec module 210 processes a first image signal view-0 in a multi-view signal, and outputs first image processed data O11 through O16. The first video codec module 210 also outputs sync information Sync_r. The sync information Sync_r is output for a row of a frame. Accordingly, the sync information Sync_r may be called row sync information. The first video codec module 210 may also output the frame sync information Sync_f. The first image signal view-0 includes a plurality of frames I11 through 116 input sequentially. Each of the frames I11 through 116 includes a plurality of rows. The first video codec module 210 may output the sync information Sync_r to the second video codec module 220 every time the first video codec module 210 processes data of a row in a frame.

The second video codec module 220 processes a second image signal view-1 in the multi-view signal, and outputs second image processed data O21 through O26. At this time, the second video codec module 220 may process the second image signal view-1 using part of the first image processed data O11 through O16, according to the sync information Sync_r output from the first video codec module 210. The first and second video codec modules 210 and 220 illustrated in FIG. 4 further include the sync transceivers 214 and 224, respectively, as compared to the first and second video codec modules 120 and 130 illustrated in FIG. 2.

The sync transceiver 214 generates the sync information Sync_r per row. Every time when the encoder 211 of the first video codec module 210 encodes data of a row in a frame of the first image signal view-0, the encoder 211 reports the sync transceiver 214 about the encoding and the sync transceiver 214 outputs the sync information Sync_r in response to the report. Every time when the decoder 212 of the first video codec module 210 decodes data of a row in a frame of the first image signal view-0, the decoder 211 reports the sync transceiver 214 about the decoding and the sync transceiver 214 outputs the sync information Sync_r in response to the report.

The sync transceiver 224 receives the sync information Sync_r from the first video codec module 210. The sync transceiver 224 determines whether a reference block of the first image signal view-0, which is referred to when a block of the second image signal view-1 is processed, has been completely processed using the sync information Sync_r. When it is determined that the reference block of the first image signal has been completely processed, the sync transceiver 224 may output a control signal for starting processing of a corresponding block of the second image signal to the encoder 221 or the decoder 222 of the second video codec module 220.

The sync transceivers 214 and 224 may perform both transmission and reception of the sync information Sync_r. For instance, the sync transceivers 214 and 224 may have both of sync information transmission and reception functions but may enable only one function (i.e., the sync information transmission or the sync information reception) when necessary.

A procedure for processing a multi-view image signal will be described in detail with reference to FIGS. 4 through 6. The multi-view image signal may be input from at least two image sources (e.g., cameras). Although it is assumed that there are two image sources and multi-view is 2-view in the current embodiments, the exemplary embodiments are not restricted to the current embodiments.

An image signal of a first view is referred to as a first image signal view-0. The first image signal view-0 may be input to the first video codec module 210 at a predetermined rate. The rate may be expressed in fps. For instance, the first image signal view-0 may be input at a rate of 60 fps. An image signal of a second view is referred to as a second image signal view-1. The second image signal view-1 may be input to the second video codec module 220 at the same rate (e.g., 60 fps) as the first image signal view-0.

The first video codec module 210 may sequentially receive and process a plurality of the frames I11 through 116 of the first image signal view-0, and may generate the sync information Sync_r every time when processing of data of a row in a frame is complemented.

Referring to FIG. 5, a frame includes a plurality of macro blocks. The frame may be divided into m*n macro blocks where “m” and “n” may be the same integer of at least 2. Although the frame includes 6*6 macro blocks in the embodiments illustrated in FIG. 5, the exemplary embodiments are not restricted to these embodiments. The frame may include 8*8-, 16*16 or 32*32-macro blocks.

A frame is a single picture and includes a plurality of pixels. For instance, there are 1000×1000 pixels in a frame shot by a 1-magapixel camera. Like typical image processing devices, an image processing apparatus according to some embodiments may process an image signal in units of macro blocks formed by grouping the pixels (e.g., 1000×1000 pixels) into N×M pixels. Here, N and M may be the same integer of at least 2. For instance, N×M may be 8×8, 16×16, or 32×32, but is not restricted thereto. In other words, each macro block includes N×M pixels.

When a frame including 1000×1000 pixels is divided into macro blocks including 8×8 pixels (i.e., 64 pixels), the frame is divided into 125×125 macro blocks. An image processing apparatus according to other embodiments may process an image signal in units of tiles formed by grouping the pixels into I×J macro blocks, where I and J are an integer of at least 1. When a frame including 125×125 macro blocks is divided into tiles including 5×25 (i.e., 125) macro blocks, the frame includes 25×5 tiles.

The second video codec module 220 sequentially receives and processes a plurality of frames I21 through I29 of the second image signal view-1. When the second video codec module 220 processes each frame of the second image signal view-1, it refers to part of the processed data of a corresponding frame of the first image signal view-0. Accordingly, the second video codec module 220 waits for a macro block to be referred to in the first image signal view-0 to be completely processed.

When the sync information Sync_r is generated by the sync transceiver 214 of the first video codec module 210 after data of a row in a frame of the first image signal view-0 is completely processed by the first video codec module 210, the sync transceiver 224 of the second video codec module 220 determines whether data of a row including a macro block to be referred to has been completely processed.

For instance, it is assumed that to process a (1,1) macro block in each frame of the second image signal view-1, a (1,1) macro block in the frame of the first image signal view-0 and its neighboring blocks (e.g., (1,2), (1,3), (2,1), (2,2), (2,3), (3,1), (3,2) and (3,3) macro blocks) in the frame of the first image signal view-0 are referred to. In this case, to process the (1,1) macro block in the first frame of the second image signal view-1, it is necessary that data of the last row (e.g., the 30th row) crossing the (3,1), (3,2) and (3,3) macro blocks in the first frame of the first image signal view-0 is completely processed.

Accordingly, when the data of the 30th row in the first frame of the first image signal view-0 is completed processed, the second video codec module 220 starts processing the (1,1) macro block in the first frame of the second image signal view-1 in response to the sync information Sync_r output from the first video codec module 210.

Let's assumed that to process a (3,1) macro block in each frame of the second image signal view-1, a (3,1) macro block in the frame of the first image signal view-0 and its neighboring blocks (e.g., (1,1), (1,2), (1,3), (2,1), (2,2), (2,3), (3,2), (3,3), (4,1), (4,2), (4,3), (5,1), (5,2) and (5,3) macro blocks) in the frame of the first image signal view-0 are referred to. In this case, to process the (3,1) macro block in the first frame of the second image signal view-1, it is necessary that data of the last row (e.g., the 50th row) crossing the (5,1), (5,2) and (5,3) macro blocks in the first frame of the first image signal view-0 is completely processed.

Accordingly, when the data of the 50th row in the first frame of the first image signal view-0 is completed processed, the second video codec module 220 starts processing the (3,1) macro block in the first frame of the second image signal view-1 in response to the sync information Sync_r output from the first video codec module 210.

The sync transceiver 224 may determine up to which row data has been processed by counting the number of times the sync information Sync_r is received. A count value of the sync transceiver 224 may be reset to an initial value (e.g., 0) at each frame. A maximum search range to be referred to for the processing of the second image signal view-1 may be different depending on codec standards used in processing image signals.

A search range is perceived by the second video codec module 220. The second video codec module 220 detects macro blocks to be referred to for processing of each macro block based on the maximum search range. Therefore, the second video codec module 220 processes the macro block of the second image signal view-1 with reference to the processed data of reference macro blocks of the first image signal view-0.

Accordingly, in the embodiments illustrated in FIGS. 4 and 6, an initial delay from a time when the first frames I11 and 121 of the respective first and second image signals view-0 and view-1 are input to a time when the first frames I11 and 121 are completely processed is shown in FIG. 6, and is shorter than the initial delay illustrated in FIG. 3.

The first image processed data O11 through O16 of the first image signal view-0 and the second image processed data O21 through O26 of the second image signal view-1 may be stored in the memory 170 or 20 (FIG. 1) or may be transmitted to a network outside the image processing system 1. The processed data O11 through O16 of the first image signal view-0 and the processed data O21 through O26 of the second image signal view-1 may be combined into a multi-view image.

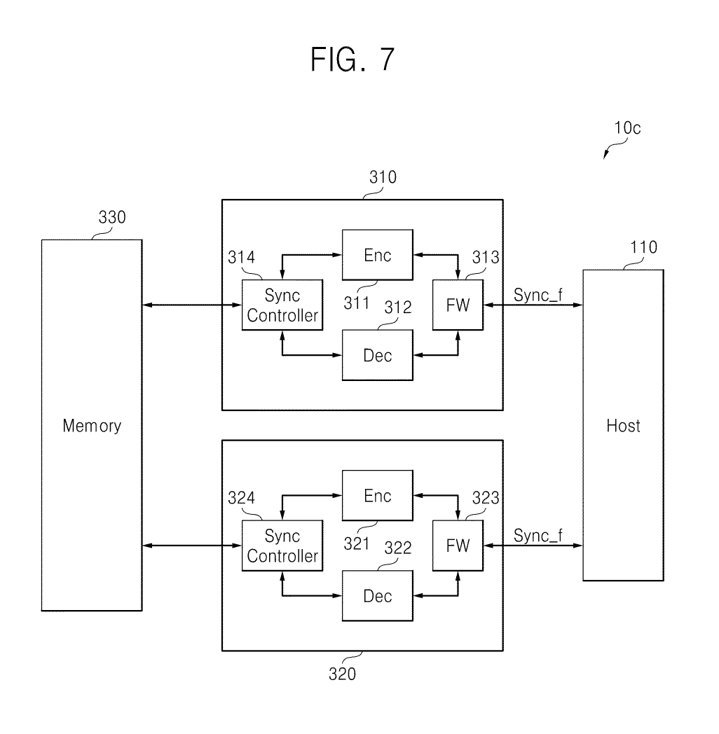

FIG. 7 is a functional block diagram of a first video codec module 310 and a second video codec module 320, according to further embodiments. Referring to FIG. 7, the first and second video codec modules 310 and 320 are connected with a bitmap memory 330.

The first video codec module 310 includes an encoder 311, a decoder 312, firmware 313, and a sync controller 314. The second video codec module 320 includes an encoder 321, a decoder 322, firmware 323, and a sync controller 324.

The first and second video codec modules 310 and 320 illustrated in FIG. 7 further include the sync controllers 314 and 324, respectively, as compared to the first and second video codec modules 110 and 120 illustrated in FIG. 2.

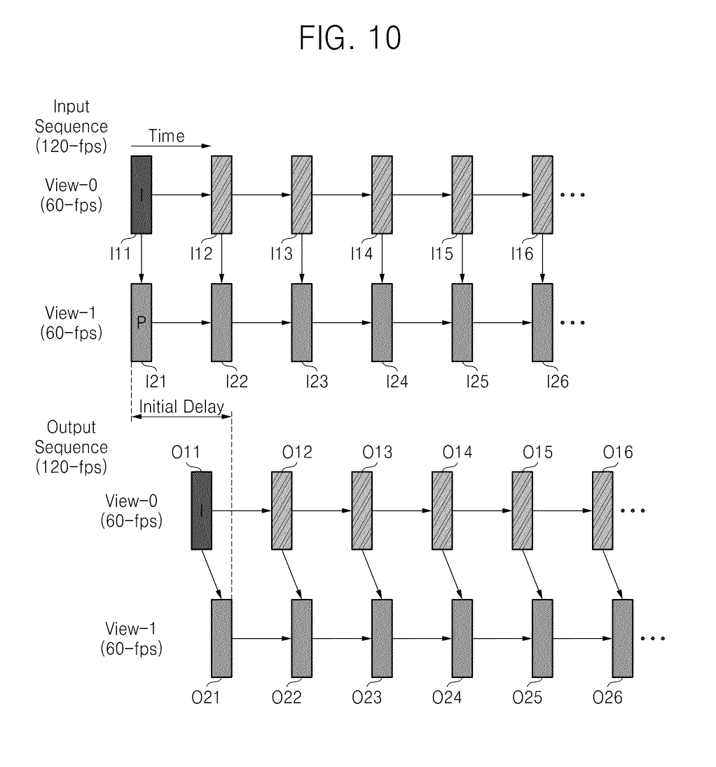

The bitmap memory 330 stores information (hereinafter, referred to as block processing information) indicating whether a macro block in a frame of a first image signal (view-0 in FIG. 10) has been processed. The bitmap memory 330 may be embedded memory (not shown) in the first or second video codec module 310 or 320, memory (e.g., 170 in FIG. 1) in a SoC, or an external memory (e.g., 20 in FIG. 1).

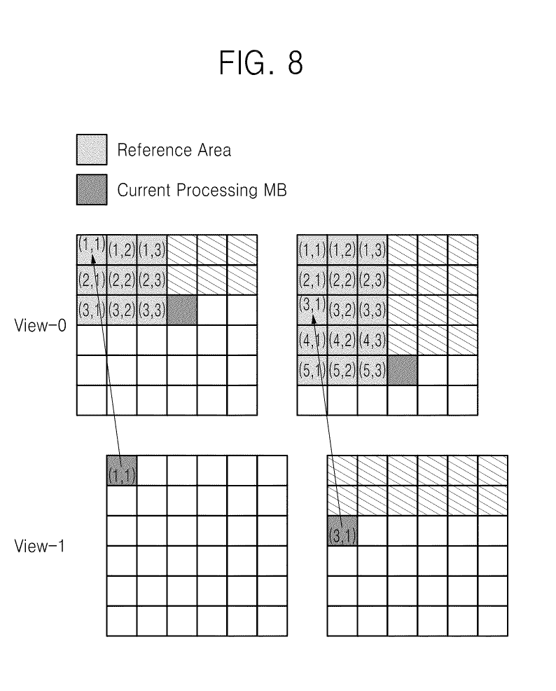

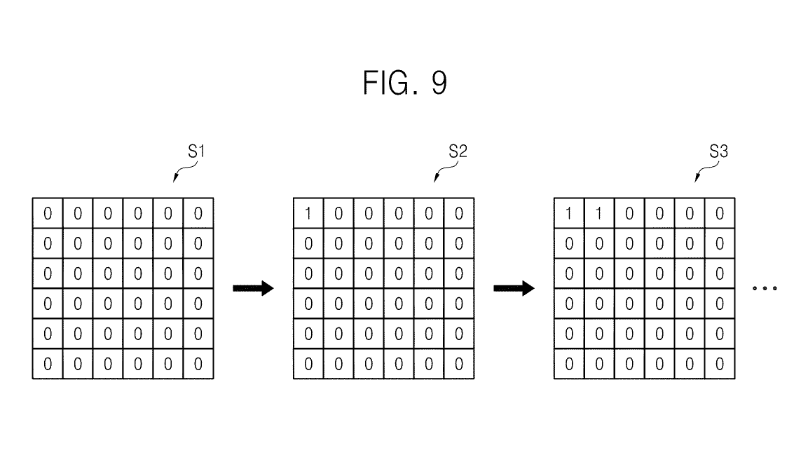

FIG. 8 is a diagram for explaining the frame structure of first and second image signals view-0 and view-1 according to other embodiments. FIG. 9 is a diagram of an example of a bitmap memory. FIG. 10 is a diagram for explaining a method of processing a multi-view image according to further embodiments. The method illustrated in FIG. 10 may be performed by an image processing apparatus 10c, including the first and second video codec modules 310 and 320 illustrated in FIG. 7.

Referring to FIGS. 7 through 10, the multi-view image signal may be input from at least two image sources (e.g., cameras). Although it is assumed that there are two image sources and multi-view is 2-view in the current embodiments, the exemplary embodiments are not restricted to the current embodiments.

An image signal of a first view is referred to as the first image signal view-0. The first image signal view-0 may be input to the first video codec module 310 at a predetermined rate. The rate may be expressed in fps. For instance, the first image signal view-0 may be input at a rate of 60 fps. An image signal of a second view is referred to as the second image signal view-1. The second image signal view-1 may be input to the second video codec module 320 at the same rate (e.g., 60 fps) as the first image signal view-0.

As shown in FIG. 8, a frame includes a plurality of macro blocks.

The first video codec module 310 sequentially receives and processes a plurality of frames I11 through 116 of the first image signal view-0. The sync controller 314 of the first video codec module 310 sets a bit in the bitmap memory 330 every time when a macro block in a frame of the first image signal view-0 is processed. For instance, when a (1,1) macro block in a first frame is processed in a state where each of bits in the bitmap memory 330 has been reset to “0” (stage S1 in FIG. 9), the sync controller 314 set a corresponding bit (e.g., a first bit) in the bitmap memory 330 to “1” (state S2 in FIG. 9). Thereafter, when a (1,2) macro block in the first frame is processed, the sync controller 314 sets a corresponding bit (e.g., a second bit) in the bitmap memory 330 to “1” (state S3 in FIG. 9). In this manner, the sync controller 314 sets a corresponding bit in the bitmap memory 330 each time when a macro block is processed.

The sync controller 324 of the second video codec module 320 reads bit values from the bitmap memory 330. For instance, the sync controller 324 of the second video codec module 320 may periodically read bit values from the bitmap memory 330.

The second video codec module 320 sequentially receives and processes a plurality of frames I21 through I26 of the second image signal view-1. When the second video codec module 320 processes each frame of the second image signal view-1, it refers to part of the processed data of a corresponding frame of the first image signal view-0. Accordingly, the second video codec module 320 waits for a macro block to be referred to, i.e., reference macro block in the first image signal view-0 to be completely processed. Whether the reference macro block has been processed is recognized by the sync controller 324 of the second video codec module 320 that reads data from the bitmap memory 330.

For instance, let's assumed that to process a (1,1) macro block in each frame of the second image signal view-1, a (1,1) macro block in the frame of the first image signal view-0 and its neighboring blocks (e.g., (1,2), (1,3), (2,1), (2,2), (2,3), (3,1), (3,2) and (3,3) macro blocks) in the frame of the first image signal view-0 are referred to. In this case, the sync controller 324 of the second video codec module 320 reads bit values from the bitmap memory 330 and determines whether bits respectively corresponding to the (1,1) macro block and its neighboring blocks (e.g., (1,2), (1,3), (2,1), (2,2), (2,3), (3,1), (3,2) and (3,3) macro blocks) have been set to “1”.

When all bits corresponding to respective reference macro blocks have been set to “1”, the second video codec module 320 starts processing the (1,1) macro block in the first frame of the second image signal view-1 with reference to processed data of the reference macro blocks in the first frame of the first image signal view-0.

Also, it is assumed that to process a (3,1) macro block in each frame of the second image signal view-1, a (3,1) macro block in the frame of the first image signal view-0 and its neighboring blocks (e.g., (1,1), (1,2), (1,3), (2,1), (2,2), (2,3), (3,2), (3,3), (4,1), (4,2), (4,3), (5,1), (5,2) and (5,3) macro blocks) in the frame of the first image signal view-0 are referred to. In this case, the sync controller 324 of the second video codec module 320 reads bit values from the bitmap memory 330 and determines whether bits respectively corresponding to the reference macro block, i.e., (3,1) macro block and its neighboring blocks (e.g., (1,1), (1,2), (1,3), (2,1), (2,2), (2,3), (3,2), (3,3), (4,1), (4,2), (4,3), (5,1), (5,2) and (5,3) macro blocks) have been set to “1”.

When all bits corresponding to the respective reference macro blocks have been set to “1”, the second video codec module 320 starts processing the (3,1) macro block in the first frame of the second image signal view-1 with reference to processed data of the reference macro blocks in the first frame of the first image signal view-0.

Processed data of each frame of the first image signal view-0 and processed data of each frame of the second image signal view-1 may be stored in the memory 170 or 20 (FIG. 1), transmitted to a network outside the image processing system 1, or combined with each other into a multi-view image.

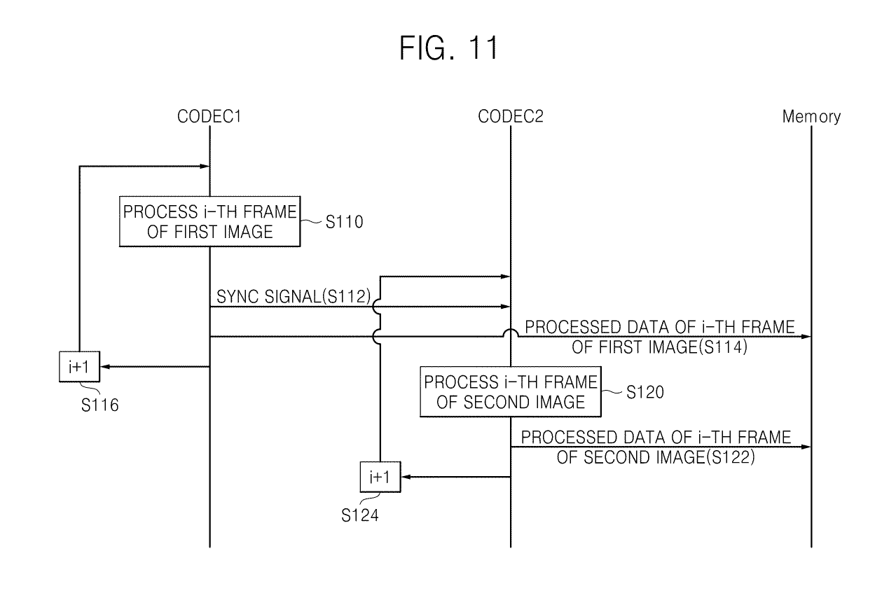

FIG. 11 is a flowchart of a method of processing a multi-view image according to some embodiments. The method illustrated in FIG. 11 may be performed by the image processing apparatus 10a illustrated in FIG. 2. Referring to FIGS. 2 an 11, the first video codec module 120 processes an i-th frame (e.g., a first frame) of a first image signal in operation S110, where “i” is an integer of at least 1. Before operation S110, “i” may be initialized.

When processing of the i-th frame is completed, the first video codec module 120 may send the sync information Sync_f to the second video codec module 130 in operation S112. The first video codec module 120 may also store processed data of the i-th frame in memory in operation S114. Then, the first video codec module 120 starts processing a subsequent frame in operations S116 and S110. In detail, “i” is increased by 1 in operation S116 and the i-th frame (e.g., a second frame) is processed in operation S110.

The second video codec module 130 processes an i-th frame (e.g., a first frame) of a second image signal in response to the sync information Sync_f in operation S 120. The sync information Sync_f generated by the first video codec module 120 may be directly sent to the second video codec module 130, but it may be sent to the host 110 so that the host 110 controls the second video codec module 130 according to the sync information Sync_f.

Therefore, the processing of the second frame by the first video codec module 120 and processing of the first frame by the second video codec module 130 are performed at the same time.

In this manner, the first video codec module 120 processes the first image signal up to the last frame and outputs the sync information Sync_f every time when each of the frames of the first image signal is processed, and the second video codec module 130 processes each frame according to the sync information Sync_f. The second video codec module 130 may also store the processed data of the i-th frame in memory in operation S122.

The processed data of each frame of the first image signal and the processed data of each frame of the second image signal, which are stored in memory, may be transmitted through a network or read and combined with each other by the host 110 or the display controller 140 (FIG. 1) to be displayed as a multi-view image on the display device 30.

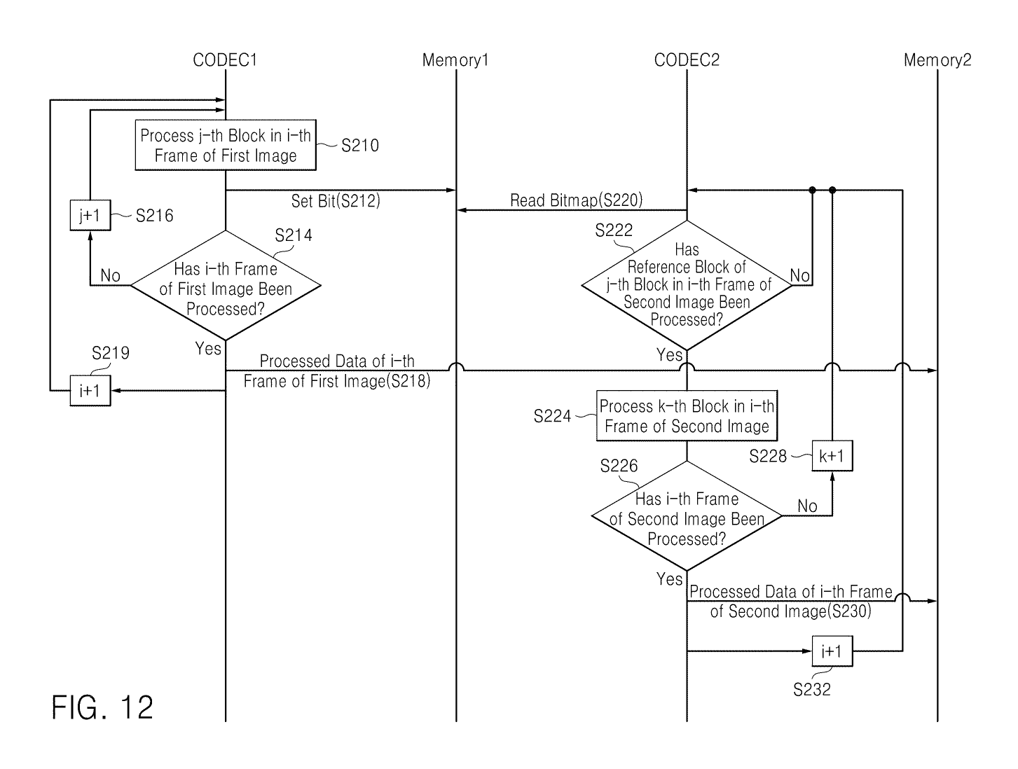

FIG. 12 is a flowchart of a method of processing a multi-view image according to other embodiments. The method illustrated in FIG. 12 may be performed by the image processing apparatus 10c illustrated in FIG. 7.

Referring to FIGS. 7 and 12, the first video codec module 310 processes a j-th macro block in an i-th frame (e.g., a first frame) of a first image signal in operation S210, where “i” and “j” are an integer of at least 1. Before operation S210, “i′ and “j” may be initialized to “1”.

When processing of the j-th macro block in the i-th frame is completed, the first video codec module 310 sets a bit corresponding to the j-th macro block in the bitmap memory 330 in operation S212. For instance, when processing of the first macro block in the first frame is completed, a corresponding bit in the bitmap memory 330 may be set to “1”, as shown in stage S2 in FIG. 9.

The first video codec module 310 repeats increasing “j” by 1 and processing a subsequent macro block in operations S214 and S216 until the i-th frame (e.g. the first frame) of the first image signal is completely processed. In other words, operations S210, S212, S214, and S216 are repeated until the i-th frame (e.g., the first frame) of the first image signal is completely processed. The first video codec module 310 may store processed data of the i-th frame in memory in operation S218.

The second video codec module 320 reads values from the bitmap memory 330 periodically or non-periodically in operation S220. The second video codec module 320 determines whether a reference macro block for a k-th macro block in the i-th frame of a second image signal has been completely processed using the values read from the bitmap memory 330 in operation S222, where “k” is an integer of at least 1. Before operation S212, “k” may be initialized to “1”. Here, the reference macro block is a macro block of the first image signal that the second video codec module 320 needs to refer to in order to process the k-th macro block of the i-th frame of the second image signal.

When it is determined that the reference macro block in the i-th frame of the first image signal has been processed in operation S222, the second video codec module 320 processes the k-th macro block in the i-th frame of the second image signal using processed data of the reference macro block of the first image signal in operation S224. However, when it is determined that the reference macro block in the i-th frame of the first image signal has not been processed in operation S222, the method goes back to operation S220 of reading values from the bitmap memory 330, and the second video codec module 320 waits for the reference macro block for the k-th macro block in the i-th frame to be completely processed.

The second video codec module 320 repeats increasing “k” by 1 and processing a subsequent macro block in operations S226 and S228 until the i-th frame (e.g. the first frame) of the second image signal is completely processed. In other words, operations S220, S222, S224, S226, and S228 are repeated until the i-th frame (e.g., the first frame) of the second image signal is completely processed. The second video codec module 320 may store processed data of the i-th frame in memory in operation S230.

In this manner, the first video codec module 310 processes the first image signal up to the last frame, and sets a corresponding bit in the bitmap memory 330 every time when a macro block in each frame is processed. The second video codec module 320 periodically or non-periodically reads values from the bitmap memory 330, and processes the second image signal up to the last frame with reference to the processed data of reference macro blocks of the first image signal.

The host 110 combines the processed data or each frame of the first image signal with the processed data of a corresponding frame of the second image signal to display a multi-view image.

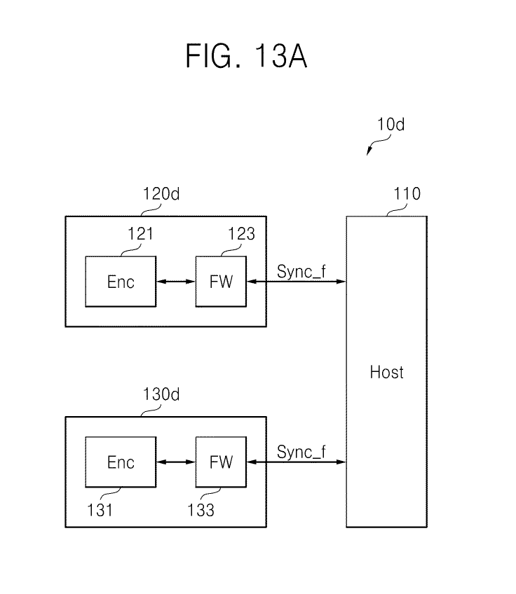

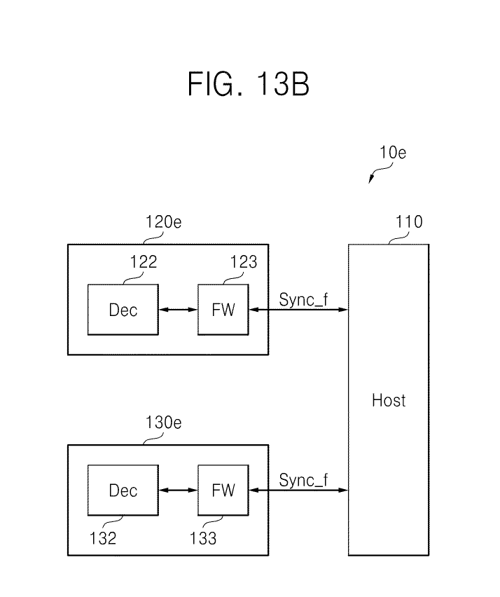

FIGS. 13A through 15B are block diagrams of the structure of first and second video codec modules according to different embodiments.

The structure of first and second video codec modules 120d and 130d illustrated in FIG. 13A is similar to that of the first and second video codec modules 120 and 130 illustrated in FIG. 2. To avoid redundancy, differences will be mainly described.

While each of the first and second video codec modules 120 and 130 includes both an encoder and a decoder in the embodiments illustrated in FIG. 2, the first and second video codec modules 120d and 130d do not include a decoder in the embodiments illustrated in FIG. 13A. In other words, the first and second video codec modules 120d and 130d may be implemented to perform only encoding, without a decoding function.

The structure of first and second video codec modules 120e and 130e illustrated in FIG. 13B is similar to that of the first and second video codec modules 120 and 130 illustrated in FIG. 2. To avoid redundancy, differences will be mainly described.

While each of the first and second video codec modules 120 and 130 includes both an encoder and a decoder in the embodiments illustrated in FIG. 2, the first and second video codec modules 120e and 130e do not include an encoder in the embodiments illustrated in FIG. 13B. In other words, the first and second video codec modules 120e and 130e may be implemented to perform only decoding, without an encoding function.

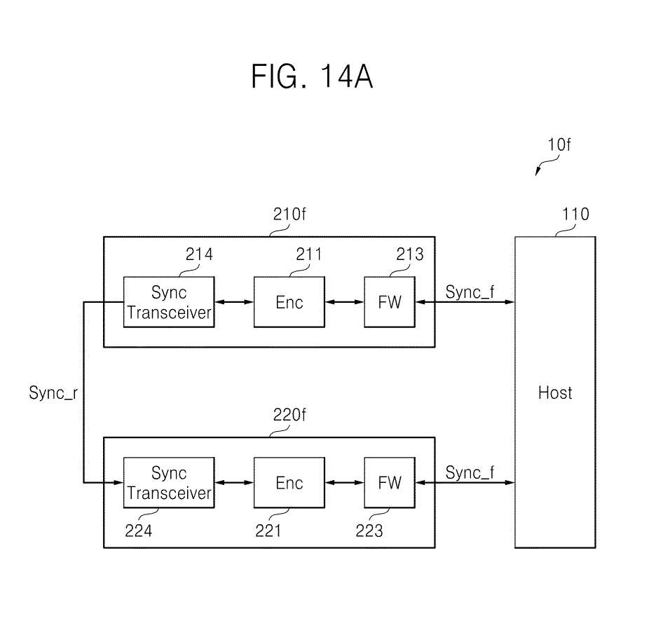

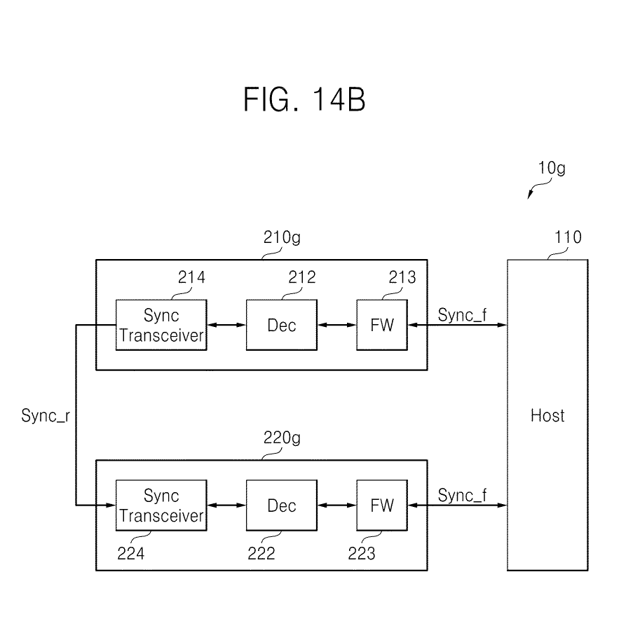

The structure of first and second video codec modules 210f and 220f illustrated in FIG. 14A is formed by excluding the decoders 212 and 222 from the respective first and second video codec modules 210 and 220 illustrated in FIG. 4. The structure of first and second video codec modules 210g and 220g illustrated in FIG. 14B is formed by excluding the encoders 211 and 221 from the respective first and second video codec modules 210 and 220 illustrated in FIG. 4.

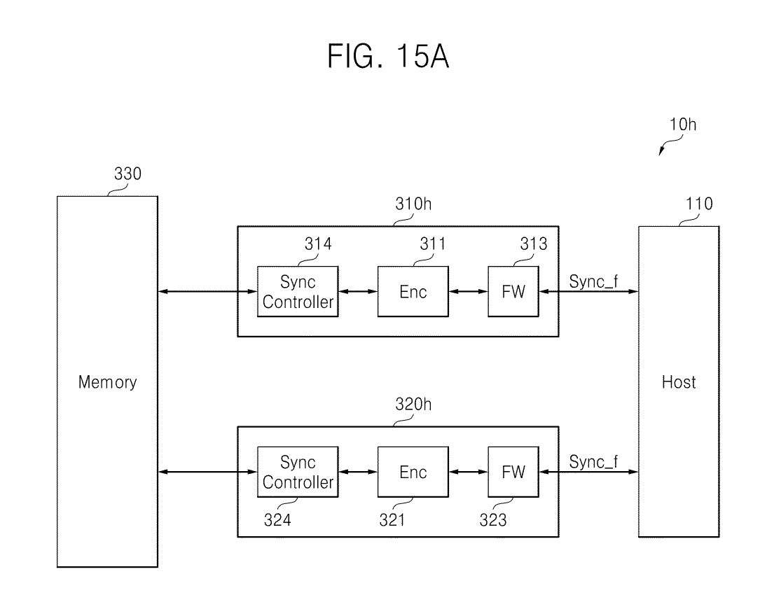

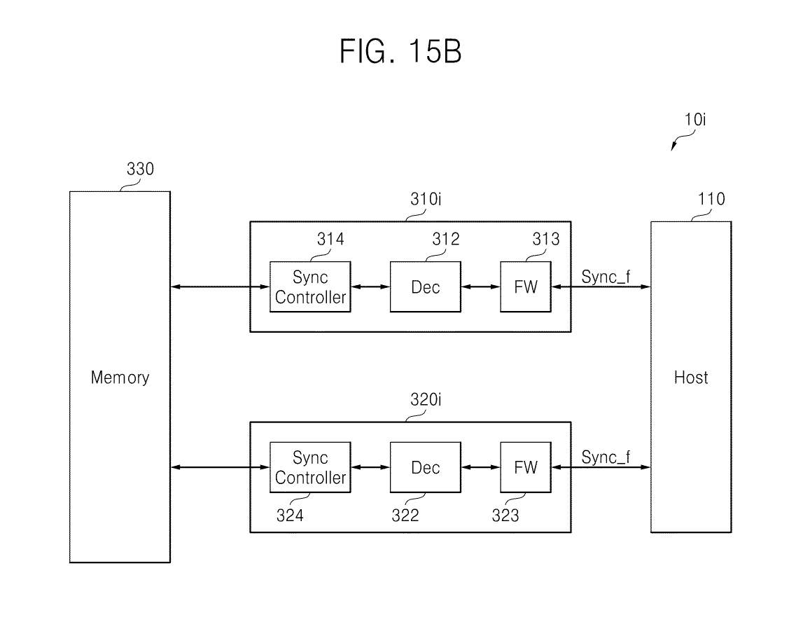

The structure of first and second video codec modules 310h and 320h illustrated in FIG. 15A is formed by excluding the decoders 312 and 322 from the respective first and second video codec modules 310 and 320 illustrated in FIG. 7. The structure of first and second video codec modules 310i and 320i illustrated in FIG. 15B is formed by excluding the encoders 311 and 321 from the respective first and second video codec modules 310 and 320 illustrated in FIG. 7.

As described above, according to some embodiments, the code module 115 may include at least two video codec modules with encoding and decoding functions to process a multi-view image, or include at least two video codec modules with only the encoding function or decoding function.

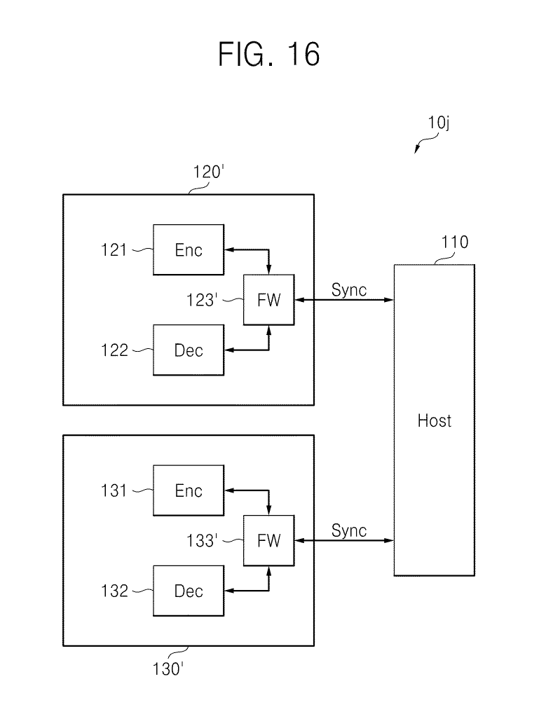

FIGS. 16 through 18 are block diagrams of the structure of first and second video codec modules according to other different embodiments.

The structure of first and second video codec modules 120′ and 130′ illustrated in FIG. 16 is similar to that of the first and second video codec modules 120 and 130 illustrated in FIG. 2. To avoid redundancy, differences will be mainly described.

Firmware 123′ of the first video codec module 120′ may transmit a sync signal Sync to the host 110 while firmware 133′ of the second video codec module 130′ receives a sync signal Sync from the host 110. At this time, the sync signal Sync may be the row sync information Sync_r described with reference to FIG. 4 or block processing information described with reference to FIG. 7. However, the exemplary embodiments are not restricted thereto.

For instance, the firmware 123′ may send the sync signal Sync to the host 110 every time the encoder 121 and the decoder 122 of the first video codec module 120′ processes data of a row or a macro block in each frame of the first image signal view-0.

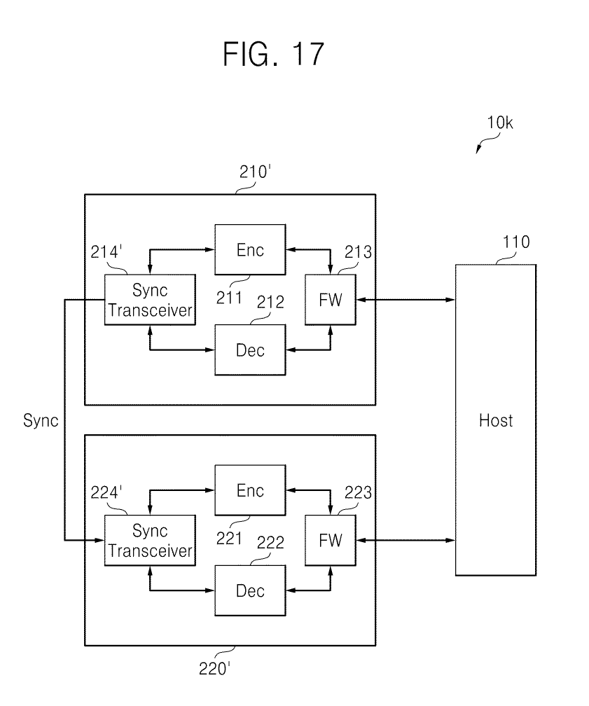

The structure of first and second video codec modules 210′ and 220′ illustrated in FIG. 17 is similar to that of the first and second video codec modules 210 and 220 illustrated in FIG. 4. To avoid redundancy, differences will be mainly described.

Referring to FIG. 17, a sync transceiver 214′ of the first video codec module 210′ may transmit a sync signal Sync to a sync transceiver 224′ of the second video codec module 220′. At this time, the sync signal Sync may be the frame sync information Sync_f described with reference to FIG. 2 or block processing information described with reference to FIG. 7. However, the exemplary embodiments are not restricted thereto. For instance, the sync transceiver 214′ may transmit the sync signal Sync to the sync transceiver 224′ of the second video codec module 220′ every time the encoder 211 and the decoder 212 of the first video codec module 210′ processes each frame of the first image signal view-0 or a macro block in each frame of the first image signal view-0.

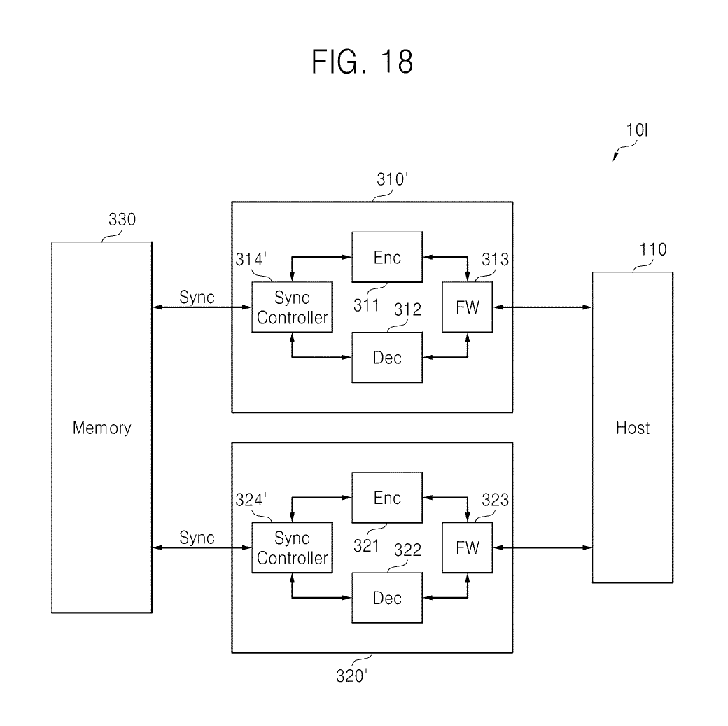

The structure of first and second video codec modules 310′ and 320′ illustrated in FIG. 18 is similar to that of the first and second video codec modules 310 and 320 illustrated in FIG. 7. To avoid redundancy, differences will be mainly described.

Referring to FIG. 18, a sync controller 314′ of the first video codec module 310′ may store a sync signal Sync in the bitmap memory 330, and a sync controller 324′ of the second video codec module 320′ may read a bit value from the bitmap memory 330. At this time, the sync signal Sync may be the frame sync information Sync_f described with reference to FIG. 2 or the row sync information Sync_r described with reference to FIG. 4. However, the exemplary embodiments are not restricted thereto. For instance, the sync controller 314′ may set a corresponding bit in the bitmap memory 330 every time the encoder 311 and the decoder 312 of the first video codec module 310′ processes each frame of the first image signal view-0 or data of row in each frame of the first image signal view-0.

In other embodiments, an encoder or a decoder may be omitted from each of first and second video codec modules with the structures illustrated in FIGS. 16 through 18.

In the exemplary embodiments, first and second video codec modules may have the same specification (e.g., the same hardware specification).

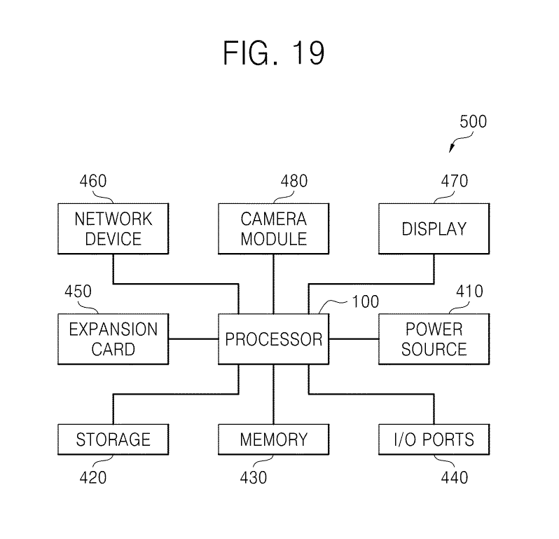

FIG. 19 is a block diagram of an image processing system 400 according to other embodiments. Referring to FIG. 19, the image processing system 400 may be implemented as a PC or a data server. The image processing system 400 may also be implemented as a portable device. The portable device may be a cellular phone, a smart phone, a tablet personal computer (PC), a personal digital assistant (PDA), an enterprise digital assistant (EDA), a digital still camera, a digital video camera, a portable multimedia player (PMP), portable navigation device (PND), a handheld game console, or an e(electronic)-book device.

The image processing system 400 includes the processor 100, a power source 410, a storage device 420, a memory 430, I/O ports 440, an expansion card 450, a network device 460, and a display 470. The image processing system 400 may further include a camera module 480.

The processor 100 corresponds to the image processing apparatus according to some embodiments.

The processor 100 may control the operation of at least one of the elements 100, and 410 through 480. The power source 410 may supply an operating voltage to at least one of the elements 100, and 420 through 480. The storage device 420 may be implemented by a hard disk drive (HDD) or a solid state drive (SSD).

The memory 430 may be implemented by a volatile or non-volatile memory. The memory 430 may correspond to the memory device 330 illustrated in FIG. 6. A memory controller (not shown) that controls a data access operation, e.g., a read operation, a write operation (or a program operation), or an erase operation, on the memory 330 may be integrated into or embedded in the processor 100. Alternatively, the memory controller may be provided between the processor 100 and the memory 430.

The I/O ports 440 are ports that receive data transmitted to the image processing system 400, or transmit data from the image processing system 400 to an external device. For instance, the I/O ports 440 may include a port connecting with a pointing device, such as a computer mouse, a port connecting with a printer, and a port connecting with a USB drive.

The expansion card 450 may be implemented as a secure digital (SD) card or a multimedia card (MMC). The expansion card 450 may be a subscriber identity module (SIM) card or a universal SIM (USIM) card.

The network device 460 enables the image processing system 400 to be connected with a wired or wireless network. The display 470 displays data output from the storage device 420, the memory 430, the I/O ports 440, the expansion card 450, or the network device 460.

The camera module 480 converts optical images into electrical images. Accordingly, the electrical images output from the camera module 480 may be stored in the storage module 420, the memory 430, or the expansion card 450. Also, the electrical images output from the camera module 480 may be displayed through a display 470.

The exemplary embodiments can also be embodied as computer-readable codes on a computer-readable medium. The computer-readable recording medium is any data storage device that can store data as a program, which can thereafter be read by a computer system. Examples of the computer-readable recording medium include read-only memory (ROM), random-access memory (RAM), CD-ROMs, magnetic tapes, floppy disks, and optical data storage devices.

The computer-readable recording medium can also be distributed over network coupled computer systems so that the computer-readable code is stored and executed in a distributed fashion. Also, functional programs, codes, and code segments to accomplish the exemplary embodiments can be easily construed by programmers.

As described above, according to some embodiments, parallel processing can be applied to multi-view image data by using multi-core, i.e., at least two video codec modules without performance deterioration.

While exemplary embodiments have been particularly shown and described, it will be understood by those of ordinary skill in the art that various changes in forms and details may be made therein without departing from the spirit and scope of the exemplary embodiments as defined by the following claims.

What is claimed is:

1. A method of processing a multi-view image using an image processing apparatus including a first video codec module and a second video codec module, the method comprising:
processing, using the first video codec module, a first frame of a first image signal and sending sync information to a host; and
processing, using the second video codec module, a first frame of a second image signal, with reference to the processed data of the first frame of the first image signal,
wherein a time in which the second video codec module starts the processing of the first frame of the second image signal is determined based on the sync information, and
wherein the first image signal and the second image signal are processed in parallel by the first video codec module and the second video codec module.

2. The method of claim 1, wherein the first image signal is provided from a first image source, and the second image signal is provided from a second image source, which is different from the first image source.

3. The method of claim 1, wherein the first and second image signals are provided from a single image source.

4. The method of claim 1, further comprising:
processing, using the first video codec module, an i-th frame of the first image signal, with reference to the processed data of at least one previous frame of the i-th frame, and sending the sync information to the host; and
processing, using the second video codec module, an i-th frame of the second image signal, with reference to the processed data of the i-th frame of the first image signal according to control of the host,
wherein “i” is an integer of at least 2.

5. The method of claim 1, wherein the sync information is frame sync information.

6. A method of processing a multi-view image using an image processing apparatus including a first video codec module and a second video codec module, the method comprising:
generating sync information, using the first video codec module, every time data of a predetermined unit has been processed in a first frame of a first image signal;
determining, using the second video codec module, whether a reference block in the first frame of the first image signal has been processed according to the sync information; and
processing, using the second video codec module, a first frame of a second image signal with reference to the processed data of the reference block.

7. The method of claim 6, wherein the predetermined unit is a row, and the sync information is row sync information.

8. The method of claim 7, further comprising:
processing, using the first video codec module, an i-th frame of the first image signal, with reference to the processed data of at least one previous frame of the i-th frame, and sending the sync information to the second video codec module every time data of each row in the i-th frame is processed;
determining, using the second video codec module, whether a reference block in the i-th frame of the first image signal has been processed according to the sync information; and
processing, using the second video codec module, an i-th frame of the second image signal, with reference to the processed data of the reference block in the i-th frame,
wherein “i” is an integer of at least 2.

9. The method of claim 6, wherein the predetermined unit is a block, and the sync information is stored in a bitmap memory.

10. The method of claim 9, further comprising:
processing, using the first video codec module, an i-th frame of the first image signal, with reference to the processed data of at least one previous frame of the i-th frame, and setting a corresponding bit in the bitmap memory every time data of each block in the i-th frame is processed;
reading, using the second video codec module, a value from the bitmap memory and determining whether a reference block in the i-th frame of the first image signal has been processed according to the value read from the bitmap memory;
processing, using the second video codec module, an i-th frame of the second image signal, with reference to the processed data of the reference block; and
combining the processed data of the i-th image of the first image signal with the processed data of the i-th frame of the second image signal into a multi-view image,
wherein “i” is an integer of at least 2.

11. The method of claim 9, wherein the bitmap memory stores bit information indicating whether the block in each frame of the first image signal has been processed.

12. A multi-view image processing apparatus comprising:
a first video codec module which is configured to output first image processed data as a result of processing a first image signal provided from a first image source, and to generate sync information at each predetermined time; and
a second video codec module which is configured to output second image processed data as a result of processing a second image signal provided from a second image source, using part of the output first image processed data according to the sync information,
wherein the first image processed data and the second image processed data are combined into a multi-view image.

13. The multi-view image processing apparatus of claim 12, wherein the first image signal and the second image signal comprise a plurality of frames, and the sync information is generated every time the first video codec module processes each of the frames of the first image signal.

14. The multi-view image processing apparatus of claim 12, wherein the first image signal and the second image signal comprise a plurality of frames, each of the frames comprises a plurality of rows,
the first video codec module comprises a first sync transceiver which is configured to generate the sync information every time data of a row in each frame of the first image signal is processed, and
the second video codec module comprises a second sync transceiver which is configured to receive the sync information from the first video codec module.

15. The multi-view image processing apparatus of claim 14, wherein each of the frames comprises a plurality of blocks,
the second sync transceiver of the second video codec module determines whether a reference block of the first image signal, which is referred to when a block of the second image signal is processed, has been processed using the sync information.

16. The multi-view image processing apparatus of claim 15, wherein each of the first and second video codec modules comprises at least one of an encoder which is configured to encode an input signal, and a decoder which is configured to decode the input signal, and when the reference block of the first image signal has been processed, the second sync transceiver of the second video codec module outputs a control signal, for starting processing of a corresponding block of the second image signal, to the encoder or the decoder of the second video codec module.

17. The multi-view image processing apparatus of claim 12, wherein the first image signal and the second image signal comprise a plurality of frames, each of the frames comprises a plurality of blocks, and
the sync information comprises bitmap data indicating whether a block in each frame of the first image signal has been processed.

18. The multi-view image processing apparatus of claim 17, wherein the first video codec module comprises a bitmap controller which is configured to set and store a bit of the bitmap data in memory every time processing of the block in each frame of the first image signal is completed, and
the second video codec module comprises a bitmap controller which is configured to read the bitmap data from the memory.

19. The multi-view image processing apparatus of claim 18, wherein the second video codec module determines whether a reference block of the first image signal, which is referred to when a block of the second image signal is processed, has been processed using the bitmap data read from the memory.

20. The multi-view image processing apparatus of claim 19, wherein each of the first and second video codec modules comprises at least one of an encoder which is configured to encode an input signal, and a decoder which is configured to decode the input signal, and when the reference block of the first image signal has been processed, the bitmap controller of the second video codec module outputs a control signal, for starting processing of a corresponding block of the second image signal, to the encoder or the decoder of the second video codec module.

21. The multi-view image processing apparatus of claim 12, wherein the first video codec module sends the sync information to a host, and the second video codec module receives the sync information from the host.

22. The multi-view image processing apparatus of claim 12, wherein the first video codec module comprises a first sync transceiver which is configured to transmit the sync information to the second video codec module, and the second video codec module comprises a second sync transceiver which is configured to receive the sync information from the first video codec module.

23. The multi-view image processing apparatus of claim 12, wherein the first video codec module stores the sync information in memory, and the second video codec module reads the sync information from the memory.

24. The multi-view image processing apparatus of claim 12, wherein the multi-view image processing apparatus is implemented as a system-on-chip (SoC).

25. An image processing system comprising;
the multi-view image processing apparatus of claim 24; and
a memory configure to store data,
wherein the multi-view image processing apparatus stores the data in the memory, and reads the data from the memory.

26. A codec module for processing a multi-view image signal, the codec module comprising:
a first video codec module which is configured to process a first image signal in the multi-view image, and output first image processing data and sync information; and
a second video codec module which is configured to process a second image signal in the multi-view image, and output second image processing data,
wherein the second video codec module processes the second image signal using part of the first image processing data according to the sync information output from the first video codec module, and
wherein the first codec module and the second codec module perform parallel processing of the multi-view image signal.

27. The codec module of claim 26, wherein the first image signal is an image signal of a first view of the multi-view image.

28. The codec module of claim 27, wherein the image signal of the first view of the multi-view image is an image shot by a first camera.

29. The codec module of claim 26, wherein the second image signal is an image signal of a second view of the multi-view image.

30. The coded module of claim 29, wherein the image signal of the second view of the multi-view image is an image shot by a second camera.
